(19) United States
(12) Patent Application Publication
(10) Pub. No.: US 2007/0288464 A1
(43) Pub. Date: Dec. 13, 2007

(54) Profile rating and verification system

(76) Inventor: Jill Silver, Tampa, FL (US)

Correspondence Address: SHUMAKER LOOP & KENDRICK, 101 E. KENNEDY, SUITE 2800, TAMPA, FL, 33672-0609, US

(21) Appl. No.: 11/451,084

(22) Filed: Jun. 12, 2006

(51) Int. Cl. G06F 17/30

(52) U.S. Cl. 707/9

(57) ABSTRACT

An Internet-based dating and social networking system in which member profiles are authenticated and rated by other members.

### COPYRIGHT NOTICE

A portion of the disclosure of this patent document may contain material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Technical Field

The following disclosure relates to on-line dating, social and business networking websites.

2. Background Information

The Internet has created a world of services that facilitate dating, social interaction, and networking. These services have revolutionized and greatly expanded the dating world. Indeed, countless anecdotes indicate that the Internet is the origin of a vast number of marriages and meaningful personal or business relationships around the world.

Internet-based dating services typically provide a member or user the ability to share his/her profile with others. Based on the contents of a user's profile, another user can decide whether the profiled user is compatible or attractive. If the user has an affinity for a particular profile, he/she can then contact the profiled user with the hope of eventually developing a meaningful relationship with the profiled user. User profiles, among other things, typically include a photograph and personal information such as age, sex, hobbies, likes and dislikes of the profiled user.

Traditional on-line dating services, however, have a number of drawbacks. At least one drawback relates to identity verification and user profile accuracy. In particular, it is relatively difficult to determine whether a user's profile is accurate because typically profiles are filled in by the actual member. In many cases, a user misstates or overstates his/her attributes or characteristics in their profile. For example, a user may indicate that he/she is taller, shorter, thinner or heavier than he/she really is in order to lure another user on a date. Another frequent problem is the use in a profile of a fraudulent photograph. For example, a user may include the photograph of someone else that is more attractive to lure another user on a date. No doubt, when users provide inaccurate information in their profile, the user that is deceived is highly disappointed and dissatisfied with their dating, socialization, or networking experience. Stated generally, conventional on-line dating services have a recognized deficiency in the ability of users to meet people living up to their expectations. One or more of these drawbacks likewise apply to business networks or other social forums.

### BRIEF SUMMARY

Accordingly, it is one aim of the following disclosure to improve upon one or more of the above-described drawbacks as well as other drawbacks of Internet-based dating services, networks, or social forums. In particular, a method is disclosed for authenticating the member profile of a first member to a third member. First, a member enrolls in the dating program by submitting an application and a profile to a website. The profile includes information about the member. The profile is then saved to a searchable database of member profiles.

The Internet based profile rating and verification system includes a rating option. By using the rating option, a member can request a meeting with another member and rate the other member's profile after the meeting. The member can rate the overall authenticity of the profile as well as individual qualities set forth in the profile. The member can further include information regarding the members experience during the meeting with the other member. Members also have the option of declining the rating option when contacted.

Authenticating and rating information regarding a particular member is then appended to the member profile and saved to the database. As a result, members can review profile authentication and rating information about specific members that have been authenticated or rated.

### BRIEF DESCRIPTION OF THE DRAWINGS

The invention will be better understood when consideration is given to the following detailed description thereof. Such description makes reference to the annexed drawings wherein:

FIG. 1 is a flow diagram of a profile rating and verification system according to one embodiment of the present invention; and

FIG. 2 is a schematic block diagram of a system architecture for use in one embodiment of the present invention.

### DETAILED DESCRIPTION OF THE DRAWINGS AND THE PRESENTLY PREFERRED EMBODIMENTS

The invention is described with reference to the drawings in which like elements are referred to by like numerals. The relationship and functioning of the various elements of this invention are better understood by the following detailed description. However, the embodiments of this invention as described below are by way of example only, and the invention is not limited to the embodiments illustrated in the drawings. It should also be understood that the drawings are not to scale and in certain instances details have been omitted, which are not necessary for an understanding of the present invention, such as conventional details of programming, fabrication, and assembly.

The present disclosure relates to an internet-based dating, socializing and networking system in which members can rate other members based on real life encounters or dates with those members. In general, the system involves creating a user profile and/or application, identifying a candidate of interest based on that candidate's reviews and/or profile, agreeing whether to date and rate the candidate, and after meeting the candidate in person, rating the candidate vis a vis the candidate's profile.

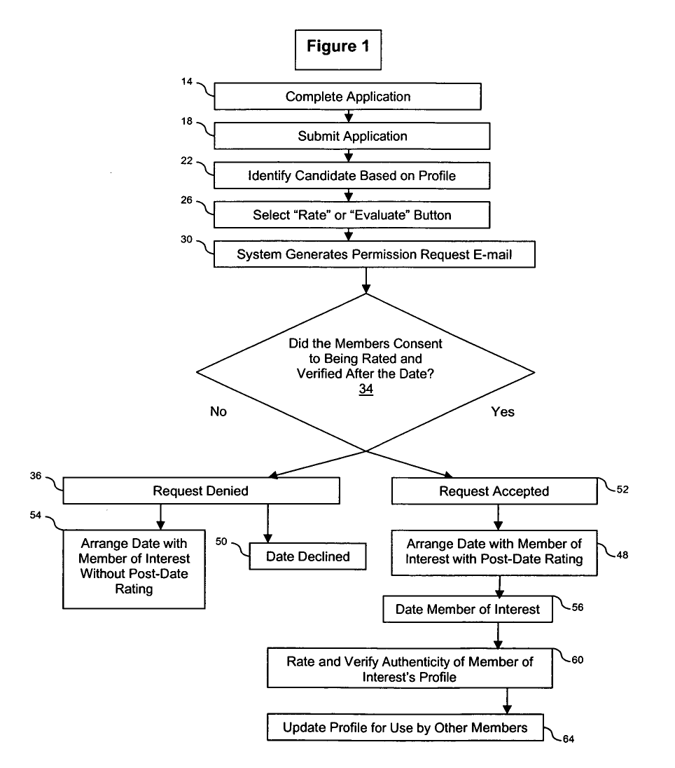

FIG. 1 illustrates one embodiment of the present invention. In step 14, a person becomes a member of the host website by completing and filing an application or profile form at the website. The profile of the person includes general and/or specific personal information about the person. For example, the profile can detail the person's age, sex, gender, likes and dislikes or other general information. The profile can also include details regarding the person's height, weight, build, and/or race. The profile can also include a photograph of the person. Once the person has been rated by other members as described below, the profile can also include rating information.

Once the application of step 14 is complete, in step 18, the person submits the application to the host website to become a member of the website. Once the person is a member, he/she can search, review and analyze the profiles of other members according to the characteristics detailed in the other members' profiles, as illustrated in step 22. When a member identifies a member of interest, he/she decides whether to require that the member of interest agree to an evaluation after the initial face-to-face meeting or date. If the member decides to require such an evaluation, the member selects the “rate” or “evaluate” button on the profile page of the member of interest, as shown in step 26.

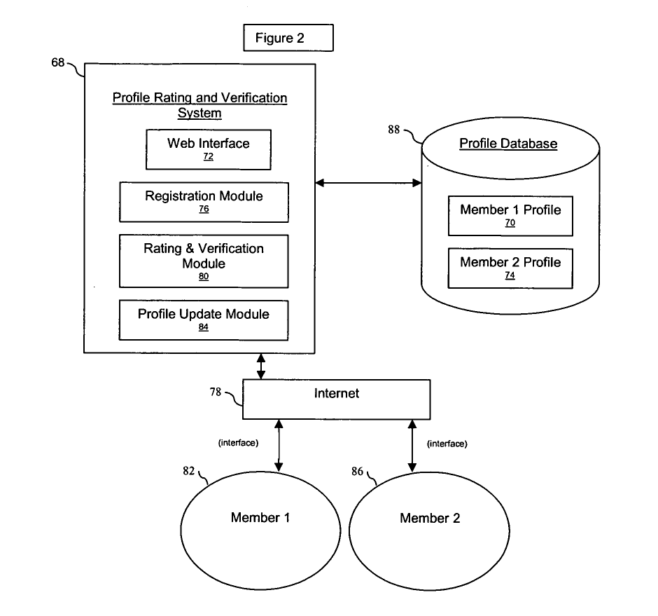

Once the “rate” or “evaluate” button is toggled or clicked, the rating and verification module 80 (illustrated in FIG. 2) generates a permission request e-mail (step 30). That e-mail is then sent to the interested member and the profiled member. Each member can then provide the other permission to rate the other person after the initial (or subsequent) face-to-face meeting(s).

As shown in step 34 of FIG. 1, the members then choose whether to be rated after the date by responding to the e-mail of step 30. If either member declines the request (step 36), then the option is provided to the other member to continue with the date without the rating option, as illustrated in step 54, or to refuse the date altogether, as illustrated in step 50. On the other hand, if the request is accepted as shown in step 52, then the members proceed and arrange an in-person date (e.g., by phone, e-mail or other means of communication) with the expectation of a post-date rating, as shown in step 48. The members then date or meet face-to-face per step 56.

After the date, the members can sign onto the website and rate each other's profile (step 60) relative to their experience on the date and verify the authenticity or accuracy of the other member's profile. The actual rating page or form is dynamic, i.e., it can be changed depending on the number of face-to-face dates. That is, on the first date, a relatively brief rating system can be used. For example, the rating form for the first date may include questions such as: Does the person look like his/her photograph? Does the person's age match the information in their profile? Does the person's body shape match the information in their profile? However, as a member proceeds additional dates with the other member, additional questions are provided to further detail the dating experience and/or the authenticity of the member profile. The rating form can also provide other readers the opportunity to read about the date experience in the member's respective blog.

As illustrated in step 64 of FIG. 1, the system 10 then updates the member profiles with the ratings, reviews or commentary of the other member.

The actual ratings can be provided in a variety of forms. For example, numerical ratings for authenticity or veracity can be used. With numerical ratings (e.g., 1-5, with 1 being “untruthful” and 5 being “completely honest”), each of the profiled qualities can be judged and verified by the rating member.

FIG. 2 illustrates a schematic block diagram of an exemplary system architecture for an embodiment of the present profile rating and verification system. The exemplary system 10 includes a profile database 88, which warehouses member profile and rating information. The profile database includes both member profiles and ratings information for two exemplary profiles 70 and 74, which correspond to members 82 and 86.

The exemplary system 10 of FIG. 2 further includes profile rating and verification system 68, which comprises web interface 72, registration module 76, rating and verification module 80, and profile update module 84. Web interface 72 provides a website accessible by members and potential members via the Internet. The website allows members the various features of the present system as described above. Registration module 76 is configured to allow members to register to the website and provide profile information, which is then warehoused in profile database 88. The rating and verification module 80 allows members to rate other members as described above and shown in FIG. 1. The profile update module 84 updates member profiles with new rating and verification information.

Members 82 and 86 can interface with the profile rating and verification system 68 through a laptop or other computing device having an Internet connection. Exemplary members 82 and 86 can access the profile rating and verification system 68 through Internet connection 78. It should be noted that additional hardware or software may be included in this system to carry out the steps of FIG. 1 or provide additional functionality, as will become apparent to one of ordinary skill in the art in view of this disclosure.

It is therefore intended that the foregoing detailed description be regarded as illustrative rather than limiting, and that it be understood that it is the following claims, including all equivalents, that are intended to define the spirit and scope of this invention.

What is claimed is:

1. A method of a first member authenticating the profile of a second member, wherein the second member's profile is located in a searchable database, the method comprising the steps of:
a) generating a first member profile having personal information relating to the first member;
b) searching the database for the second member profile based on predetermined profile qualities;
c) locating the second member profile;
d) sending a first electronic mail to the second member requesting consent from the second member to authenticate the second member's profile based on a comparison of the second member's actual qualities and the qualities provided in the second member's profile;
e) receiving an electronic mail from the second member, wherein the second member consents to the authentication of the second member's profile by the first member;
f) meeting the second member in person; and
g) authenticating the second member's profile based on a comparison of the second member's actual qualities and the qualities provided in the second member's profile.

2. The method of claim 1, further comprising the step of updating the second member's profile with ratings of the second member's profile authenticity.

3. The method of claim 2, wherein the second member's profile comprises a description of the second member's appearance and personality.

4. The method of claim 3, wherein the ratings further comprise a rating of the similarity between the appearance of the second member and the description of the second member's appearance set forth in the second member's profile.

5. The method of claim 4, wherein the ratings further comprise a rating of the similarity between the personality traits of the second member and the description of the second member's personality set forth in the second member's profile.

6. The method of claim 5 further comprising the step of sending the first member and the second member an electronic mail confirming the impending meeting between the first member and the second member and the time, place, and manner of the meeting.

7. The method of claim 6, wherein the second member's profile comprises a general description of the second member's finances.

8. The method of claim 7, wherein the ratings further comprise a rating of the similarity between the finances of the second member and the description of the second member's finances set forth in the second member's profile.

9. A method of authenticating a member profile of a first member by a second member to a third member, wherein the first member profile is located in a searchable database of member profiles, the method comprising the steps of:
a) receiving and saving to the database at least a first member profile having information relating to the first member;
b) receiving and saving to the database at least a second member profile having information relating to the second member;
c) providing a rating option to the second member;
d) receiving a request for the rating option from the second member, the request comprising:
i. a request for a meeting with the first member,
ii. a request for the first member's consent for the second member to rate the first member,
iii. consent to be rated by the first member;
e) confirming by electronic mail the meeting between the first member and the second member;
f) receiving authentication information from the second member for authentication of the first member profile; and
g) authenticating the first member profile by appending authentication information to the first member profile and publishing the authentication information along with the first member profile, whereby a third party can analyze the authenticity of the first member profile based on the appended authentication information.

10. The method of claim 9, further comprising the step of receiving a member profile from the third member in exchange for access to the database.

11. The method of claim 10, wherein the first member profile comprises a photograph of the first member, the age of the first member, the height of the first member, and the weight of the first member.

12. The method of claim 11, wherein the authentication information comprises information regarding the authenticity of the photograph of the first member, the age of the first member, the height of the first member, and the weight of the first member based on the second member's personal experience with the first member.

13. The method of claim 12, further comprising receiving a rating for the personality of the first member based on the second member's personal experience with the first member.
